(19) United States
(12) Patent Application Publication
(10) Pub. No.: US 2007/0012208 A1
(43) Pub. Date: Jan. 18, 2007

(54) Offset printing system

(76) Inventors: Byungwoo Cho, Seoul (KR); Namsoon Kim, Seoul (KR); Kyuheang Cho, Seoul (KR); Boheang Cho, Seoul (KR)

Correspondence Address: NEUSTEL LAW OFFICES, LTD., 2534 SOUTH UNIVERSITY DRIVE, SUITE 4, FARGO, ND, 58103, US

(21) Appl. No.: 11/368,218

(22) Filed: Mar. 3, 2006

(30) Foreign Application Priority Data
Jul. 13, 2005 (KR) 10-2005-63394
Jan. 5, 2006 (JP) 2006-18320

(51) Int. Cl. B41F 1/46

(52) U.S. Cl. 101/363

(57) ABSTRACT

A offset printing system for maintaining printability of offset printing ink. The offset printing system includes a suction pipe formed to fit within an ink fountain, a pump connected to a connecting pipe, a valve connected to the connecting pipe, a heater, a filter including a first filter and a second filter, a vacuum device including a disc and a stirrer, a heat exchanger connected to the connecting pipe and a discharge pipe formed to fit within the ink fountain.

### CROSS REFERENCE TO RELATED APPLICATIONS

I hereby claim benefit under 35 U.S.C. § 119 of Korean patent application number 10-2005-63394 filed on Jul. 13, 2005 and Japanese patent application number 2006-18320 filed on Jan. 5, 2006. The 10-2005-63394 application and 2006-18320 application are hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to offset printing systems and more specifically it relates to an offset printing system for maintaining printability of offset printing ink.

2. Description of the Related Art

Any discussion of the prior art throughout the specification should in no way be considered as an admission that such prior art is widely known or forms part of common general knowledge in the field.

Offset printing systems have been in use for years. Typically, on the printing press, plates are dampened by water rollers and then ink rollers. Ink is distributed from the ink fountain to the plates. Image areas of the plate receive ink from the ink rollers. The ink is then transferred through a blanket to the printing paper.

Etch solution formulated with chemicals based on water from the water fountain is fed back into the ink fountain. After time, etch solution changes color and viscosity of the printing ink. This causes problems such as mottling, dot gain, poor drying of ink, etc. This etch solution continues to build up as the printing press runs causing excessive build up of ink and foreign materials on the printing plate.

While these devices may be suitable for the particular purpose to which they address, they are not as suitable for maintaining printability of offset printing ink. Printing problems are partly or in whole related to excessive etch solution content in the ink. Etch solution builds up with foreign materials (e.g., lint, dust from the paper) and is fed back into the ink fountain either through ink train or through the air.

In these respects, the offset printing system according to the present invention substantially departs from the conventional concepts and designs of the prior art, and in so doing provides an apparatus primarily developed for the purpose of maintaining printability of offset printing ink.

### BRIEF SUMMARY OF THE INVENTION

In view of the foregoing disadvantages inherent in the known types of offset printing systems now present in the prior art, the present invention provides a new offset printing system construction wherein the same can be utilized for maintaining printability of offset printing ink.

The general purpose of the present invention, which will be described subsequently in greater detail, is to provide a new offset printing system that has many of the advantages of the offset printing systems mentioned heretofore and many novel features that result in a new offset printing system which is not anticipated, rendered obvious, suggested, or even implied by any of the prior art offset printing systems, either alone or in any combination thereof.

To attain this, the present invention generally comprises a suction pipe formed to fit within an ink fountain, a pump able to connect to a connecting pipe, a valve connected to the connecting pipe, a heater, a filter including a first filter and a second filter, a vacuum device including a disc and a stirrer, a heat exchanger connected to the connecting pipe and a discharge pipe formed to fit within the ink fountain.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an offset printing system that will overcome the shortcomings of the prior art devices.

A second object is to provide an offset printing system for maintaining printability of offset printing ink.

Another object is to provide an offset printing system that removes excessive etch content in an ink fountain.

An additional object is to provide an offset printing system that controls undesirable viscosity that may occur between etch solution and printing ink.

A further object is to provide an offset printing system that allows printing ink to remain at a constant temperature suitable for printing.

Another object is to provide an offset printing system that moves ink horizontally to evenly mix water and ink.

Another object is to provide an offset printing system that removes habitual scrap of remaining ink after the job.

Another object is to provide an offset printing system that eliminates aversive conditioning of printing.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side view of a configuration of the present invention.

FIG. 2 is a side view of the suction pipe used in the present invention.

FIG. 3 is a side view of the discharge pipe used in the present invention.

FIG. 4 is a side view of the vacuum device used in the present invention.

FIG. 5 is a side view of the filter used in the present invention.

FIG. 6a is a side view of a configuration of the present invention with ink pumped through the suction pipe from the ink fountain.

FIG. 6b is a side view of a configuration of the present invention with ink transferred past first pump.

FIG. 6c is a side view of a configuration of the present invention with ink transferred through heater and first filter.

FIG. 6d is a side view of a configuration of the present invention with heated ink transferred through second filter.

FIG. 6e is a side view of a configuration of the present invention with heated and cleaned ink transferred through vacuum device.

FIG. 6f is a side view of a configuration of the present invention with heated and cleaned ink transferred through second pump.

FIG. 6g is a side view of a configuration of the present invention with cleaned ink transferred through heat exchanger and replaced in ink fountain through discharge pipe.

FIG. 7a is a side view of a configuration of the present invention with ink pumped through the discharge pipe from the ink fountain.

FIG. 7b is a side view of a configuration of the present invention with ink transferred through alternate connecting pipe.

FIG. 7c is a side view of a configuration of the present invention with ink transferred through second pump.

FIG. 7d is a side view of a configuration of the present invention with ink transferred through alternate connecting pipe into vacuum device for storage.

FIG. 8 is a flow chart of the present invention explaining the system flow.

### DETAILED DESCRIPTION OF THE INVENTION

A. Overview

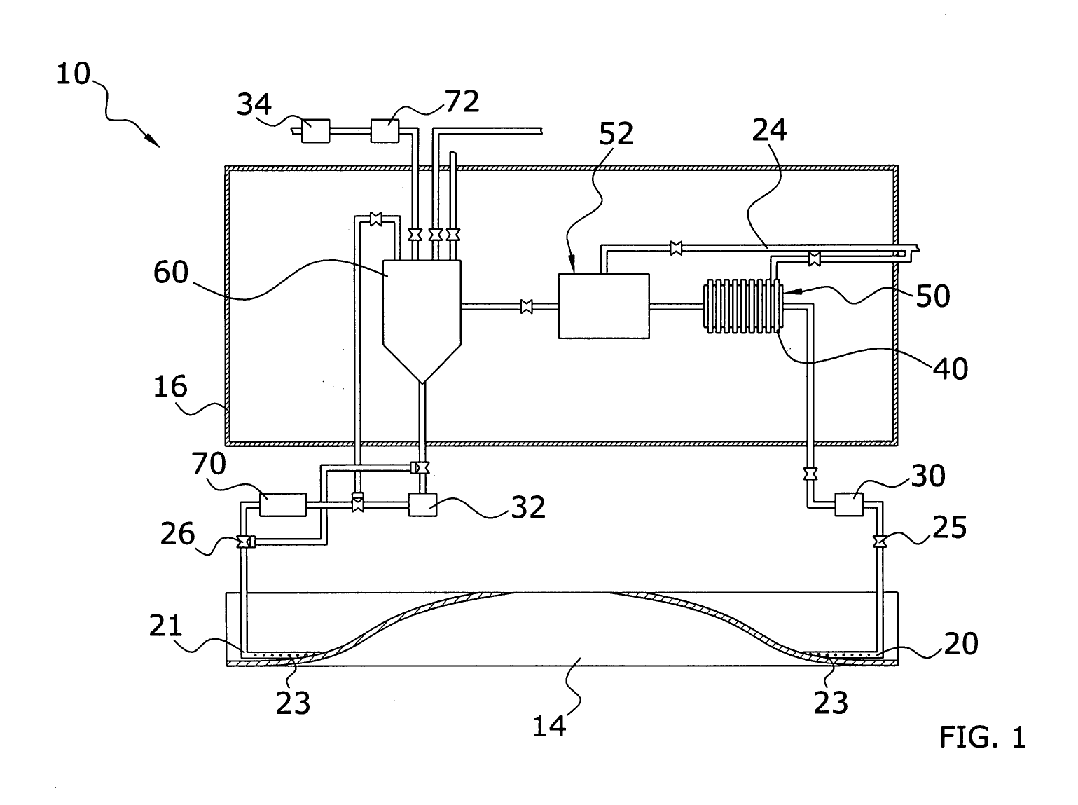

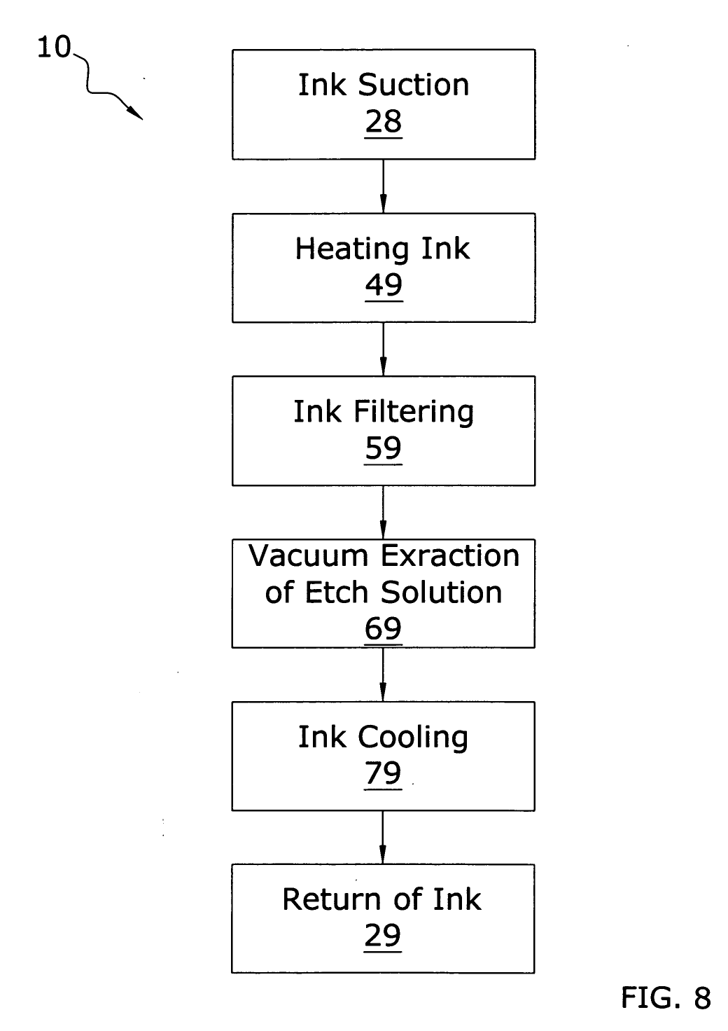

Turning now descriptively to the drawings, in which similar reference characters denote similar elements throughout the several views, FIGS. 1 through 8 illustrate a offset printing system 10, which comprises a suction pipe 20 formed to fit within an ink fountain 14, a pump connected to a connecting pipe 24, a valve connected to the connecting pipe 24, a heater 40, a filter including a first filter 50 and a second filter 52, a vacuum device 60 including a disc 66 and a stirrer 67, a heat exchanger connected to the connecting pipe 24 and a discharge pipe 21 formed to fit within the ink fountain 14.

B. Suction Pipe and Discharge Pipe

The suction pipe 20 and the discharge pipe 21 are comprised of similar structures and configurations that are suitable for receiving an ink substance 12 from the ink fountain 14 and replacing an ink substance 12 back into the ink fountain 14. The suction pipe 20 and the discharge pipe 21 are formed in a way to be easily removable and attachable for cleaning of the offset printing system 10. The suction pipe 20 and the discharge pipe 21 have an opening at a pipe end 22 to receive the ink substance 12 from the ink fountain 14 and to replace the ink substance 12 back into the ink fountain 14.

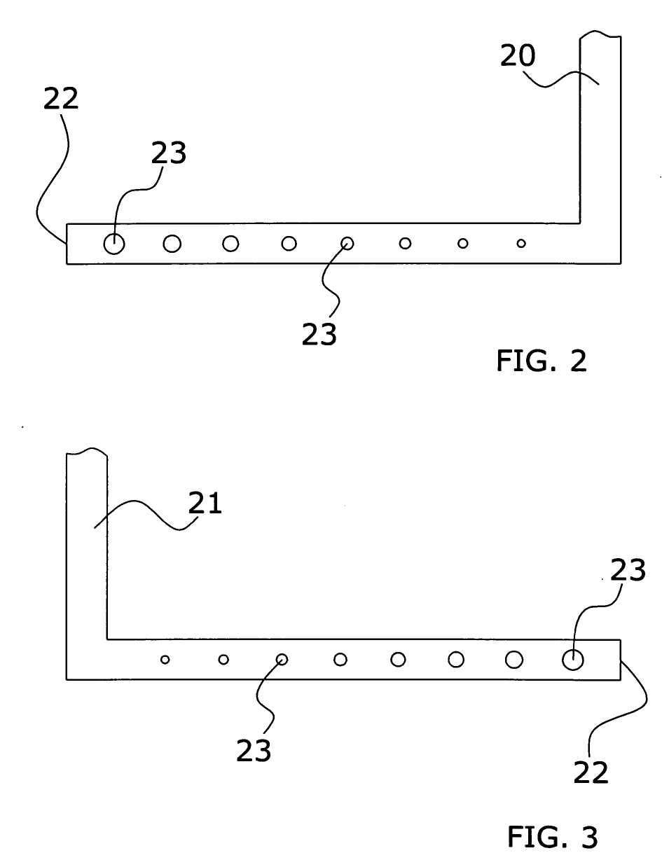

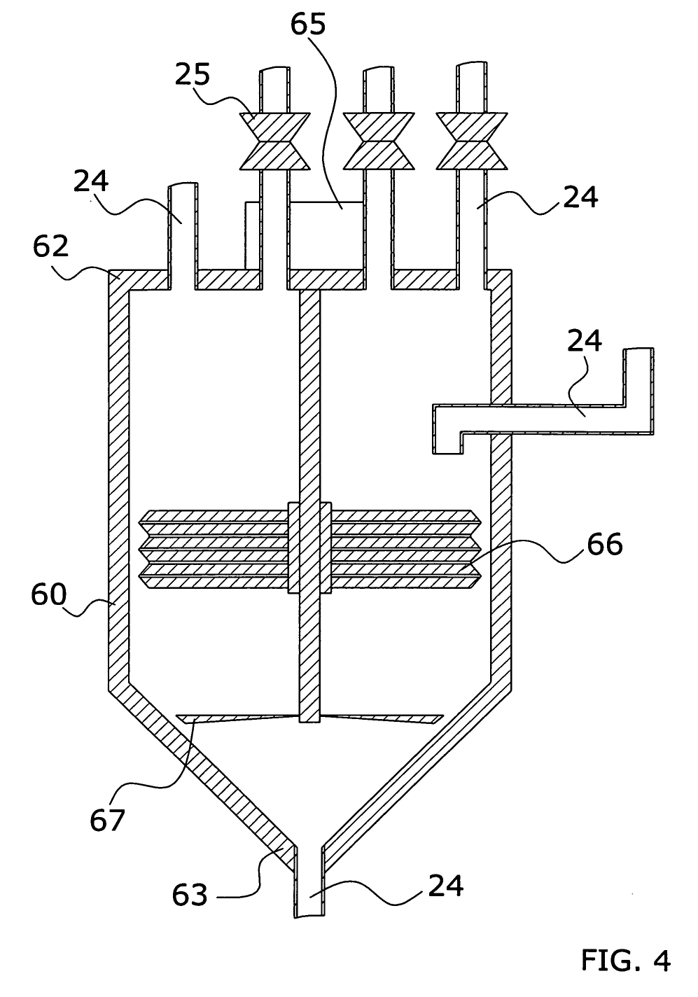

As shown best in FIGS. 2 and 3, there are preferably multiple apertures 23 positioned lengthwise on the suction pipe 20 and the discharge pipe 21. Preferably, the apertures 23 get larger as the aperture 23 gets closer to the pipe end 22. This configuration and size of the apertures 23 helps to equalize the speed of the suction and discharge.

i) Connecting pipe

A connecting pipe 24 is preferably of a cylindrical shape, as to allow an ink substance 12, cleaning solution to travel easily through the offset printing system 10. The connecting pipe 24 is preferably easily attachable to embodiments in the offset printing system 10.

C. Valve

The offset printing system 10 preferably includes a first valve 25 and a second valve 26. The first valve 25 and the second valve 26 are preferably of a configuration that is easily attachable to a connecting pipe 24.

The first valve 25 and the second valve 26 may be opened or closed depending on the position of the ink substance 12 in the offset printing system 10. As shown in FIG. 1 and FIGS. 6a through 7e, the first valve 25 controls the ink substance 12 as the ink substance 12 flows through a single connecting pipe 24.

The second valve 26 is formed in a way to be connectable to two connecting pipes 24. The second valve 26 is opened to allow the ink substance 12 to flow through the alternate connecting pipe 24 during storing of the ink substance 12.

D. Pump

The offset printing system 10 preferably includes a first pump 30, a second pump 32 and a third pump 34. The first pump 30 and the second pump 32 are preferably of similar configurations. The third pump 34 is preferably of a configuration of a vacuum pump.

As shown in FIG. 1 and FIGS. 6a through 7e, the first pump 30 is preferably attached to the suction pipe 20, and serves to pump the ink substance 12 from the ink fountain 14. The first pump 30 is also preferably attached to a connecting pipe 24.

As shown in FIG. 1 and FIGS. 6a through 7e, the second pump 32 is preferably attached to the connecting pipe 24 that transfers the ink substance 12 from the vacuum device 60. Preferably, the second pump 32 transfers the ink substance 12 back into the ink fountain 14 through the discharge pipe 21.

As shown in FIG. 1 and FIGS. 6a through 7e, the third pump 34 preferably pumps the excessive etch solution out of a vacuum device 60. The excessive etch solution is processed for reuse or disposal according to the specific properties of the etch solution.

E. Heater

As shown in FIG. 1 and FIGS. 6a through 7e, the heater 40 is preferably in the configuration of a band heater 40 as to be wrapped around the first filter 50. The heater 40 preferably heats up the ink substance 12 to a temperature that allows for easy removal of excessive etch solution and debris from the ink substance 12. The heater 40 is also preferably formed to fit within a housing 16 as to conserve heat during the offset printing system 10 process.

F. Filter

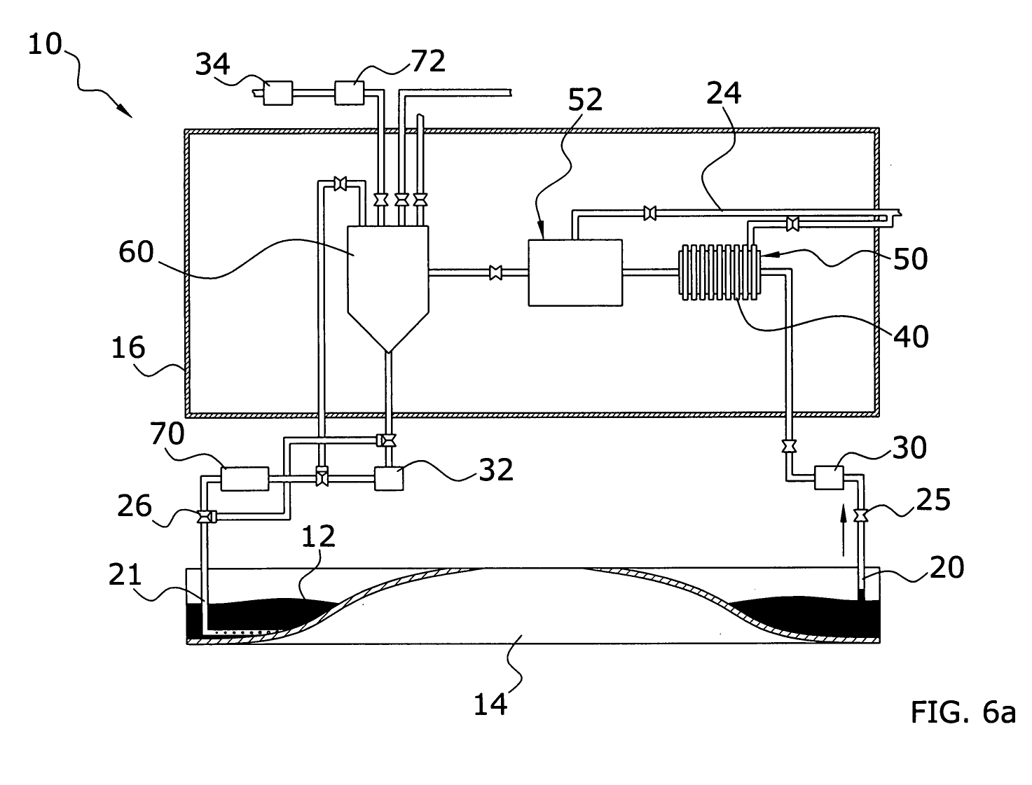

The first filter 50 and the second filter 52 are preferably comprised of similar configurations. As shown in FIG. 5, the first filter 50 and the second filter 52 each preferably include an outer case 54, an inner case 55, cover 56 and a filter member 57. As shown in FIG. 1 and FIGS. 6a through 7e, the first filter 50 and the second filter 52 are formed to fit within the housing 16.

The connecting pipe 24 is inserted through the outer case 54, the inner case 55 and into the filter member 57. To receive the filtered ink substance 12, another connecting pipe 24 is attached to the alternate end of the outer case 54. The connecting pipe 24 is inserted through the outer case 54 and the inner case 55. Attached to the cover 56 is another connecting pipe 24 which allows a cleaning solution to enter the first filter 50 and the second filter 52. The cleaning solution is controlled from entering the first filter 50 and the second filter 52 by a first valve 25 which is attached to the connecting pipe 24. The cover 56 may be easily removed from the first filter 50 or the second filter 52 in case the filter member 57 needs replacement.

G. Vacuum Device

The vacuum device 60 is preferably of a cylindrical shape and includes the disc 66 and the stirrer 67. The disc 66 and the stirrer 67 are powered by a motor 65, which preferably operates at a speed of 100 to 200 RPM. As shown in FIG. 1 and FIGS. 6a through 7e, the vacuum device 60 is positioned within the housing 16 to keep the ink substance 12 heated during operation. The vacuum device 60 may also be attached to a heater 40, to provide further heat to the ink substance 12.

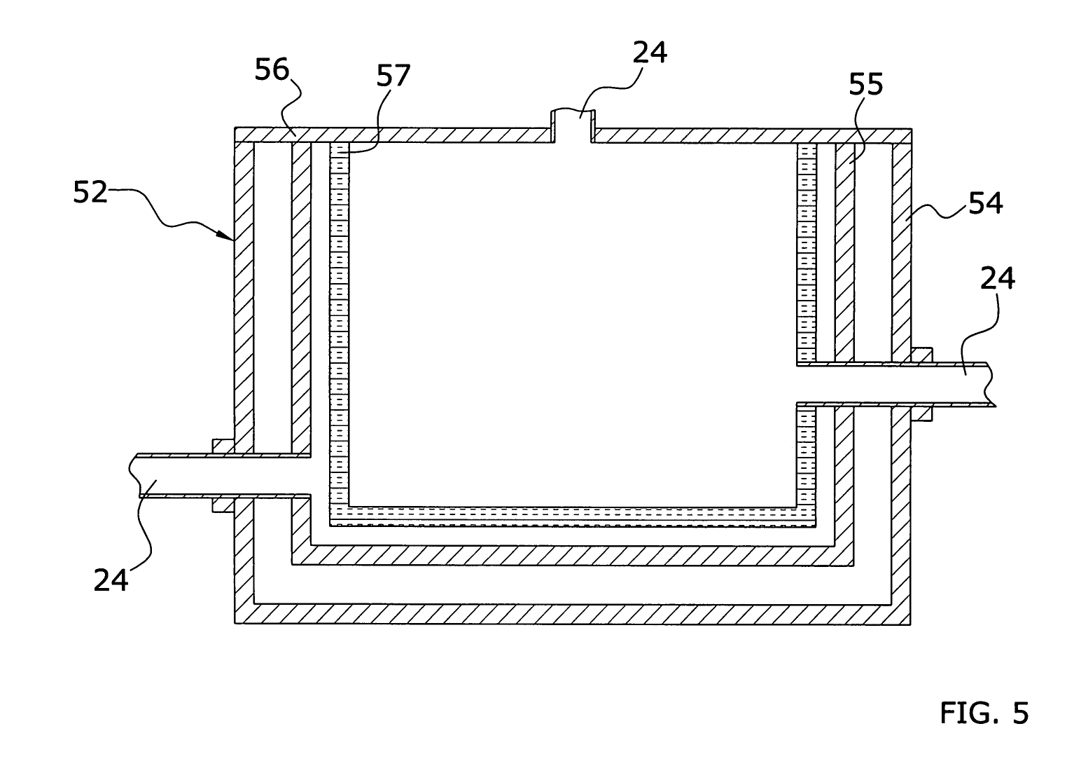

As shown in FIG. 4, the ink substance 12 enters the vacuum device 60 through the connecting pipe 24. After removal of the excessive etch solution, the ink substance 12 leaves the vacuum device 60 through the connecting pipe 24 preferably positioned at a lower end 63 of the vacuum device 60. As shown in FIG. 4, several connecting pipes 24 (for storing the ink substance 12, removing etch solution, and cleaning the vacuum device 60) are located at an upper end 62 of the vacuum device 60.

H. Heat Exchanger

A heat exchanger includes a first heat exchanger 70 and a second heat exchanger 72. The first heat exchanger 70 and the second heat exchanger 72 are preferably positioned outside of the housing 16 and are able to attach to a connecting pipe 24.

The first heat exchanger 70 is preferably positioned near the discharge pipe 21 and cools the purified ink substance 12 before re-entering the ink fountain 14. The second heat exchanger 72 is preferably attached to the connecting pipe 24 that may include the excessive etch solution that is removed by the vacuum device 60. The second heat exchanger 72 cools down the etch solution to a temperature where it may be safely reused or disposed.

I. In Use

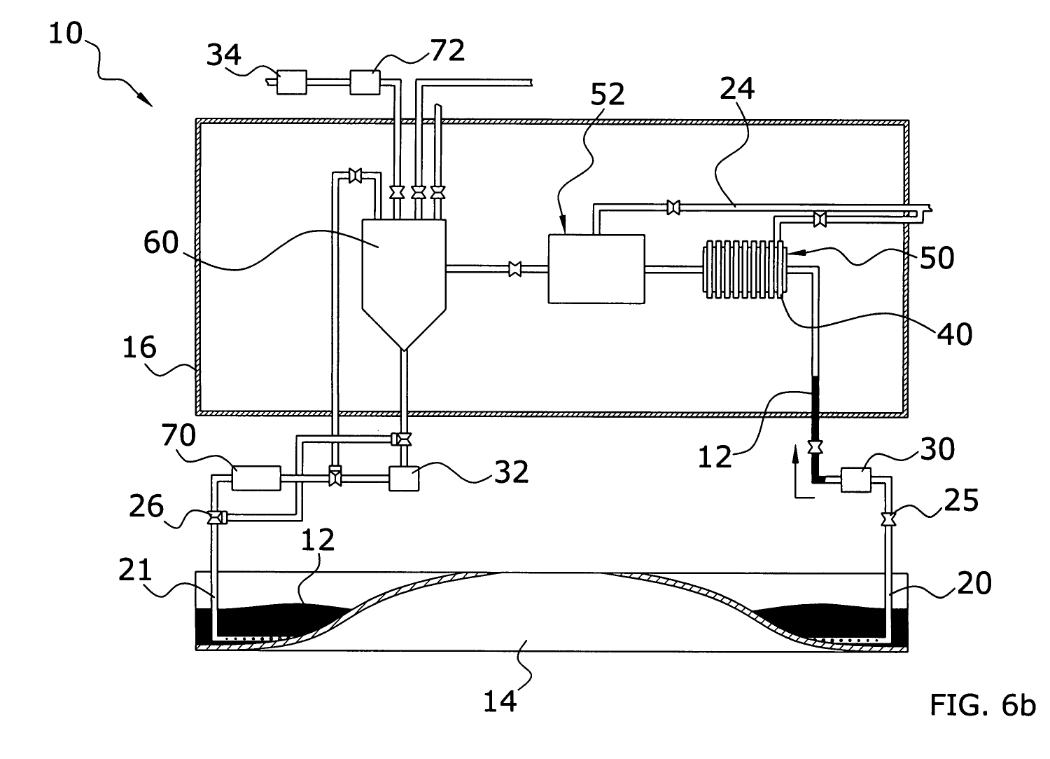

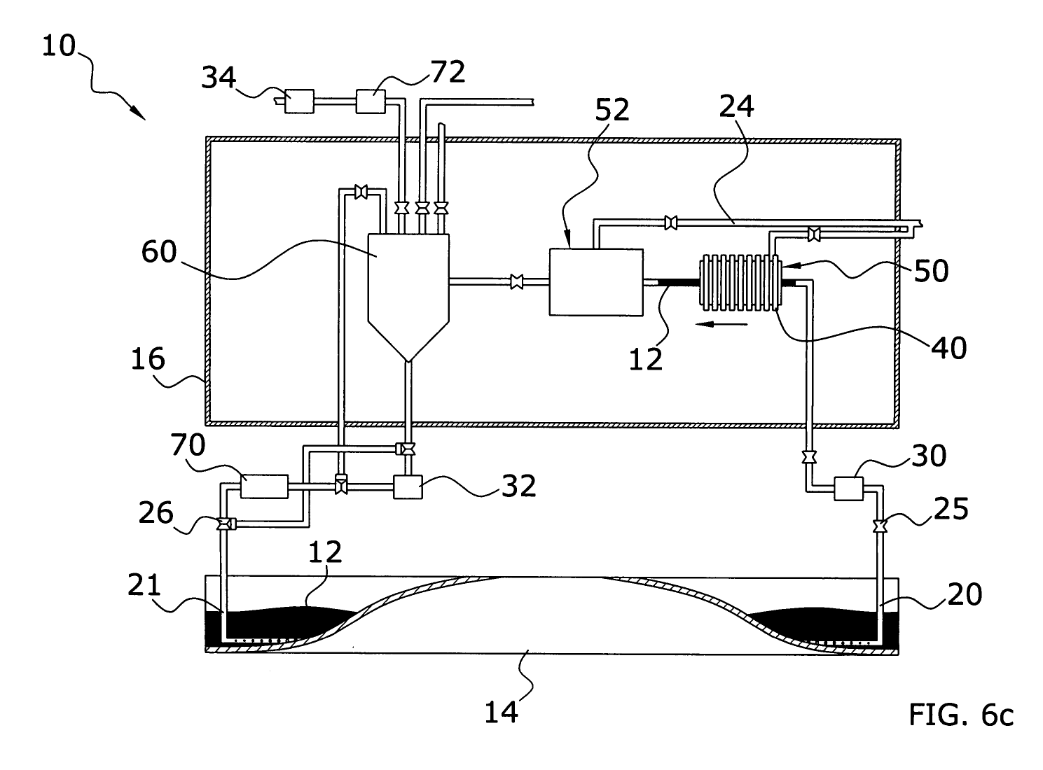

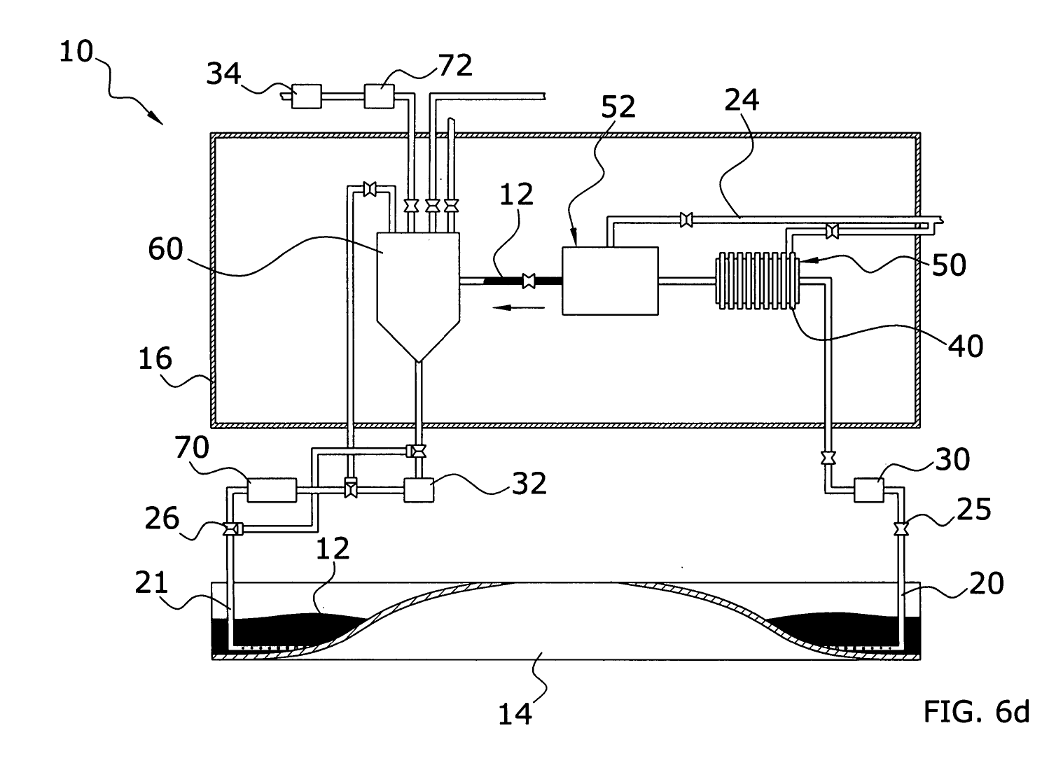

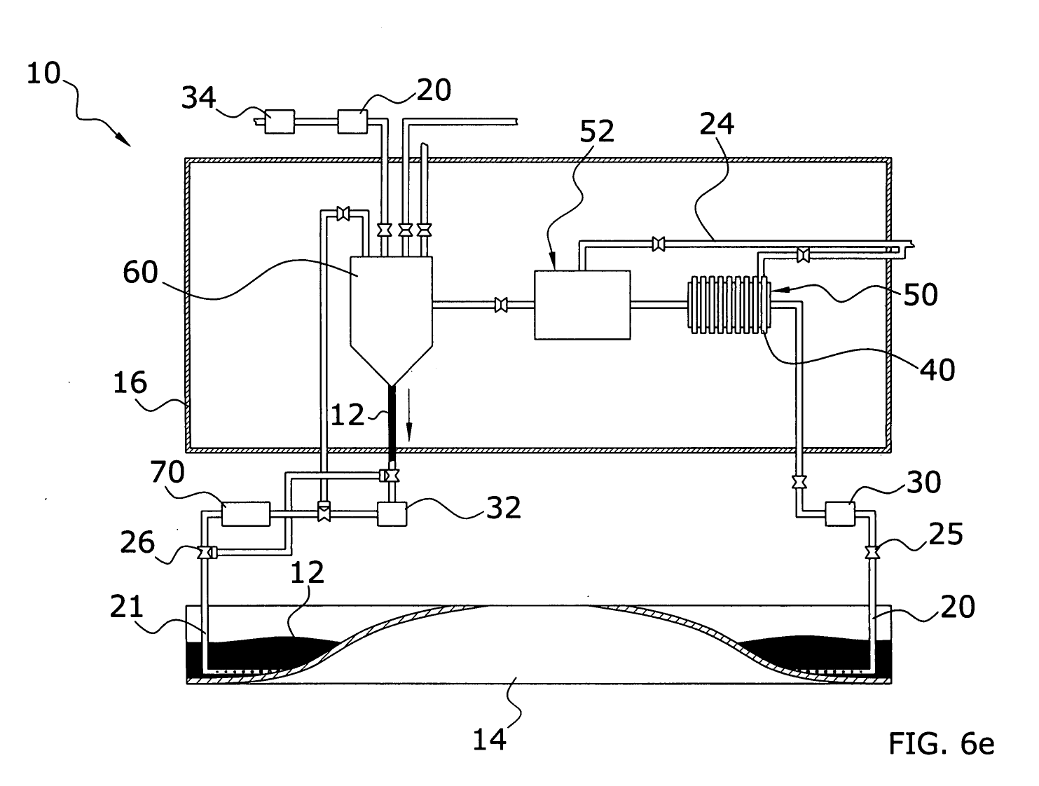

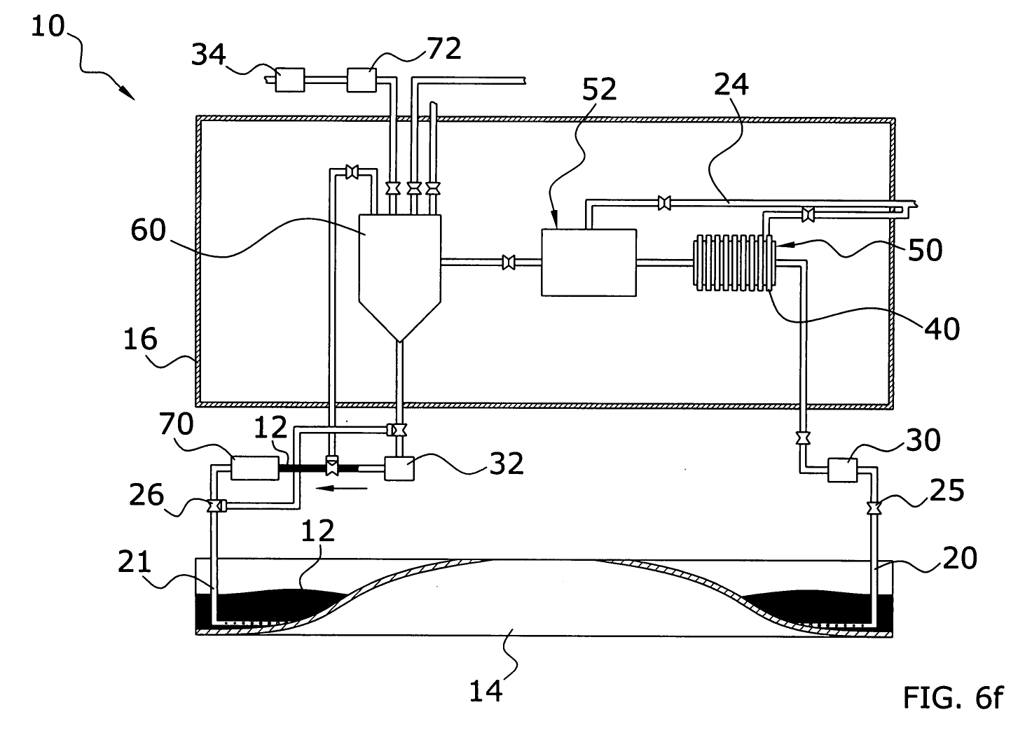

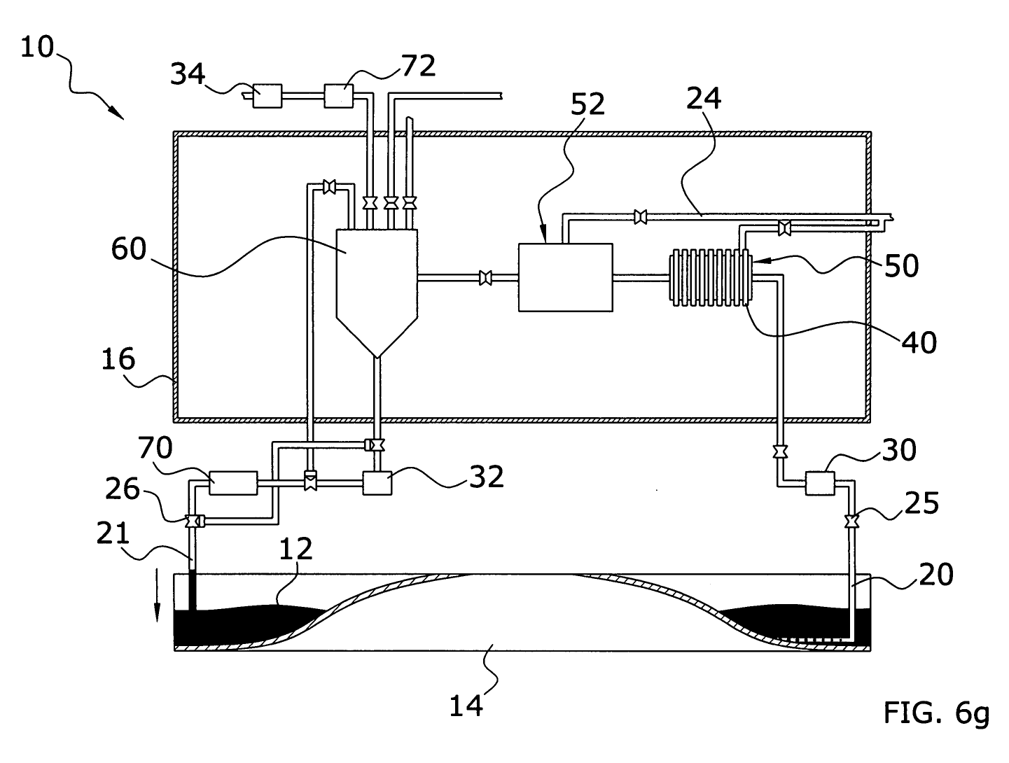

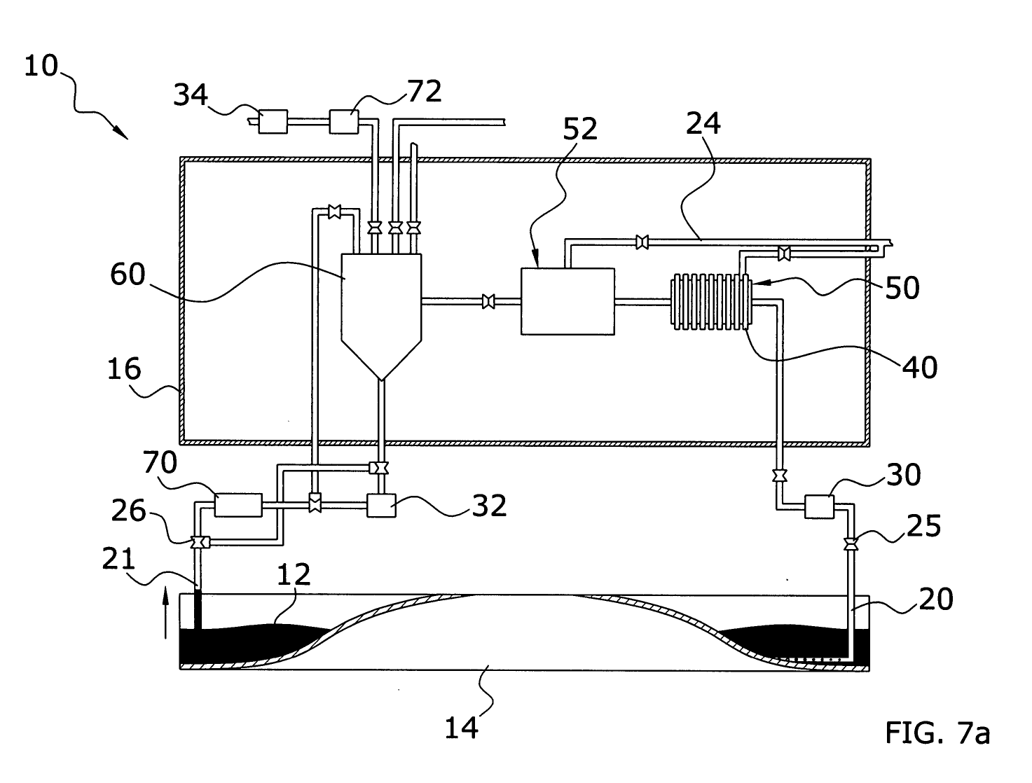

To extract the excessive etch content from the ink substance 12, the ink substance 12 is received from the ink fountain 14, via a suction pipe 20. As shown in FIG. 6a, the ink substance 12 is pumped through the suction pipe 20, via the first pump 30. As shown in FIG. 6b, after the ink substance 12 passes through the first pump 30, the ink substance 12 enters the housing 16 through the connecting pipe 24.

The ink substance 12 now enters the first filter 50, which is attached to the heater 40. As shown in FIG. 6c, the ink substance 12 is heated to an appropriate temperature for removal of debris and excessive etch solution and passes through the first filter 50. As shown in FIG. 6c, the heated ink substance 12 then passes through the connecting pipe 24 and the second filter 52, which further removes excess debris. The heated and filtered ink substance 12 now enters the vacuum device 60 through the connecting pipe 24.

The motor 65 of the vacuum device 60 rotates the disc 66 and the stirrer 67. Once, the ink substance 12 enters the vacuum device 60, the ink substance 12 rotatably travels down the edge of a disc 66. Ink substance 12 is then slipped down the vacuum device 60 spreading widely around the inside of the vacuum device 60 for maximum exposure. At the lower end 63 of the vacuum device 60, the ink substance 12 is stirred with a stirrer 67. The stirrer 67 creates a whirlwind effect, which forces the excessive etch solution through the connecting pipe 24 at the upper end 62 of the vacuum device 60.

The excessive etch solution is pumped up the connecting pipe 24 by the third pump 34. The etch solution travels through the second heat exchanger 72 and is cooled to a temperature where the etch solution may be safely reused or disposed.

Once the excessive etch solution has been removed from the ink substance 12, the ink substance 12 leaves the vacuum device 60 and subsequently leaves the housing 16, as shown in FIG. 6e. The purified and heated ink substance 12 is pumped out of the vacuum device 60 and out of the housing 16 by the second pump 32. As shown in FIG. 6f, the second pump 32 then pumps the purified ink substance 12 into the first heat exchanger 70, where the purified ink substance 12 is cooled to an appropriate temperature for printing. The cooled and purified ink substance 12 is replaced back into the ink fountain 14 through the discharge pipe 21, as shown in FIG. 6g.

J. Storing

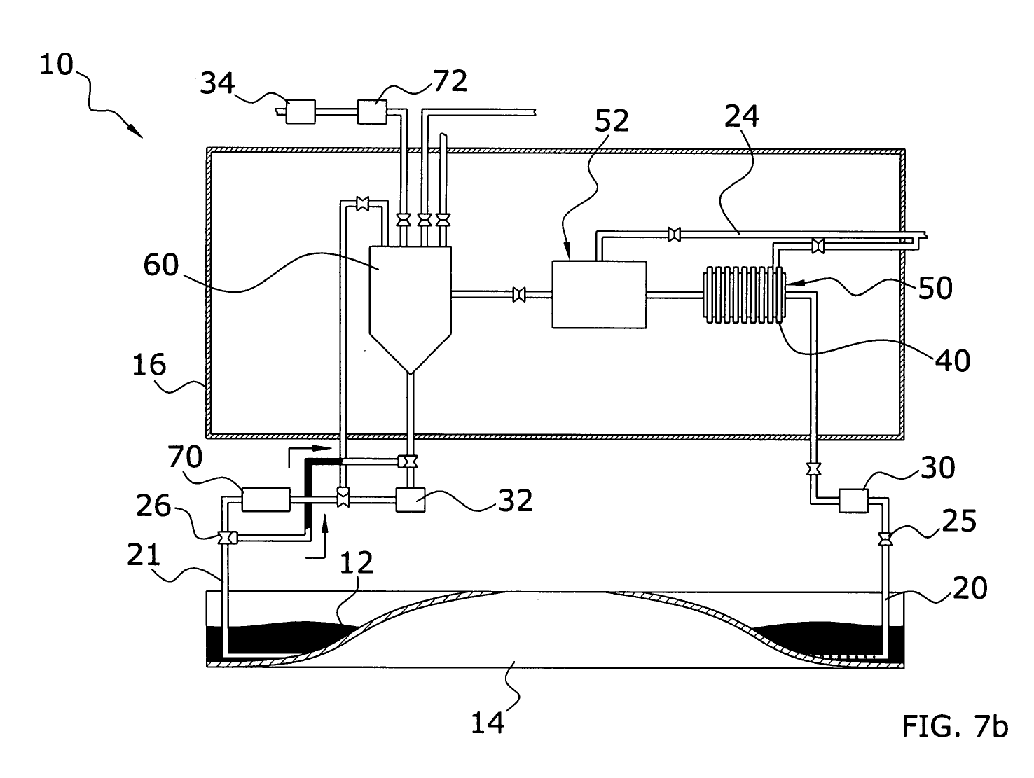

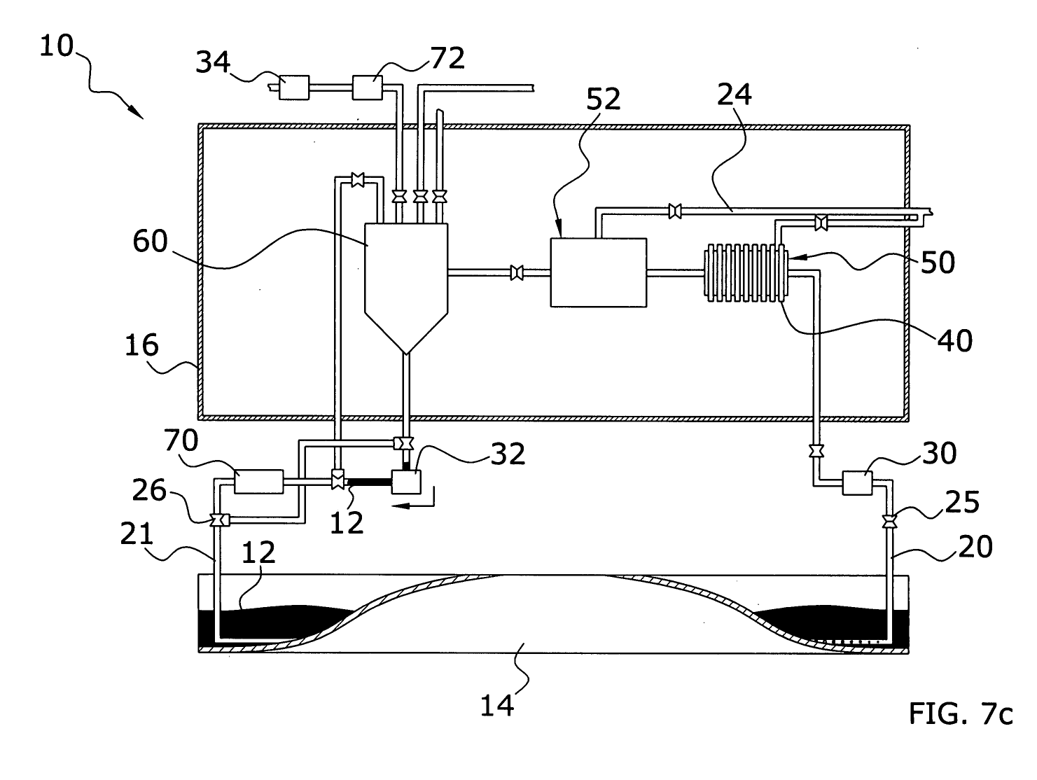

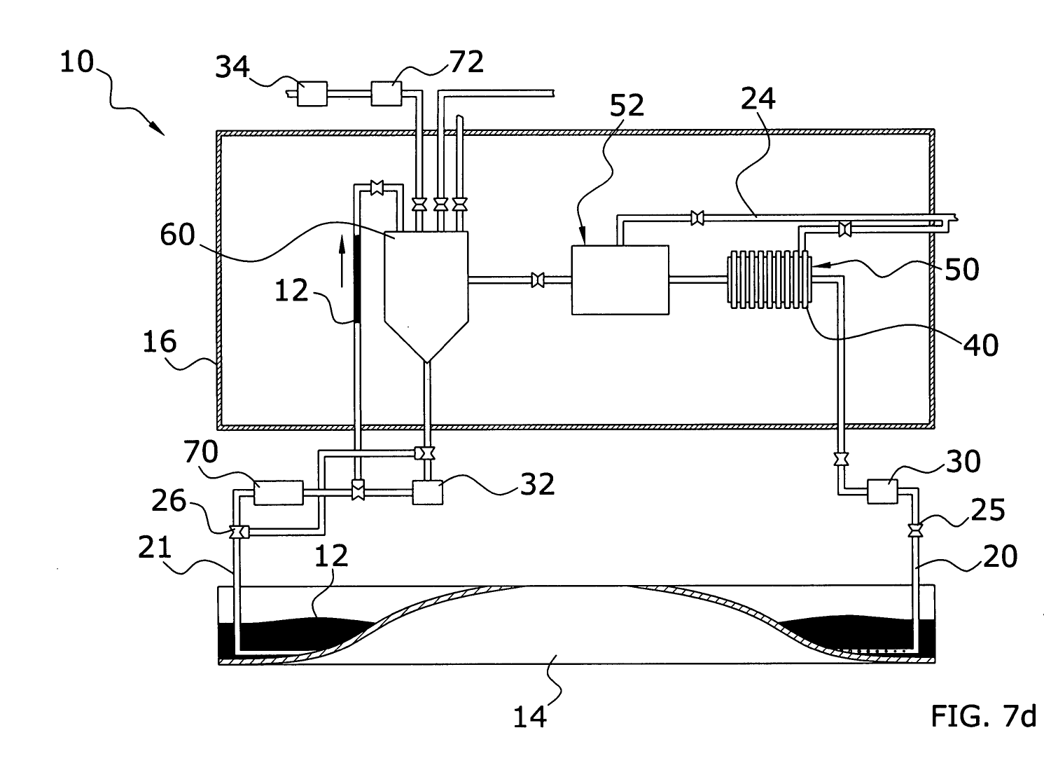

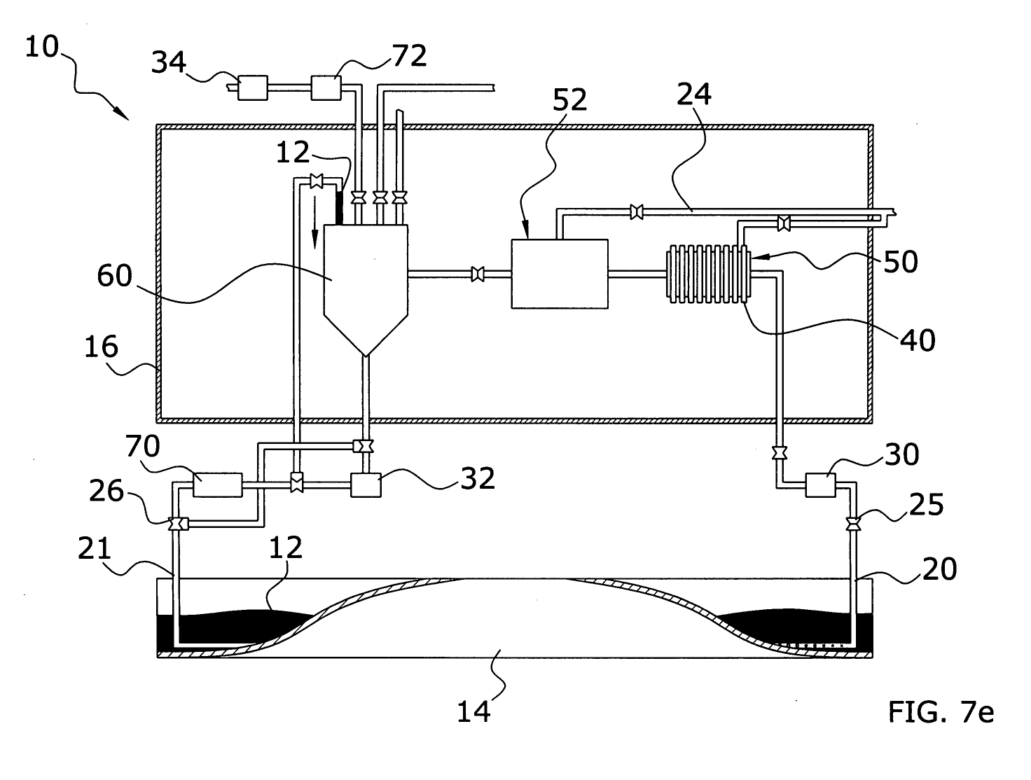

To store the ink substance 12 when not printing, ink is pumped through the discharge pipe 21 by the second pump 32, as shown in FIG. 7a. The second valve 26 opens up to allow the ink substance 12 to flow through an alternate connecting pipe 24, as shown in FIG. 7b.

The ink substance 12 continues through the connecting pipe 24 and into the housing 16, as shown in FIG. 7d. As shown in FIG. 7e, the ink substance 12, then travels through the open first valve 25 and into the vacuum device 60, where it may be stored.

K. Cleaning

The vacuum device 60, the first filter 50 and second filter 52 of the offset printing system 10 may be easily cleaned during nonuse. The first valves 25 are opened that lead the connecting pipes 24 into the cover 56 of the first filter 50, the cover 56 of the second filter 52 and the upper end 62 of the vacuum device 60. Cleaning solution may now flow through the connecting pipes 24 leading to the first filter 50, the second filter 52 and the vacuum device 60.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

We claim:

1. An offset printing system, comprising:
a suction pipe formed to fit within an ink fountain;
a pump connected to a connecting pipe;
a valve connected to said connecting pipe;
a heater;
a filter including a first filter and a second filter;
a vacuum device including a disc and a stirrer;
a heat exchanger connected to said connecting pipe; and
a discharge pipe formed to fit within said ink fountain.

2. The offset printing system of claim 1, wherein said suction pipe includes a pipe end.

3. The offset printing system of claim 2, wherein said suction pipe includes one or more apertures.

4. The offset printing system of claim 3, wherein said apertures on said suction pipe have varying diameters.

5. The offset printing system of claim 4, wherein said suction pipe may be easily removable for cleaning of said offset printing system.

6. The offset printing system of claim 1, wherein said pump includes a first pump, a second pump and a third pump.

7. The offset printing system of claim 1, wherein said valves may be opened or closed depending on position of said ink substance.

8. The offset printing system of claim 7, wherein said valve includes a first valve and a second valve.

9. The offset printing system of claim 8, wherein said second valve is bi-directional.

10. The offset printing system of claim 1, wherein said heater is wrapped around said first filter.

11. The offset printing system of claim 10, wherein said first filter and said second filter include an outer case, an inner case, a cover and a filter member.

12. The offset printing system of claim 11, wherein said cover of said first filter and said cover of said second filter attach to said connecting pipe that transfers a cleaning substance to said first filter and said second filter.

13. The offset printing system of claim 1, wherein said vacuum device includes said disc and said stirrer which are powered by a motor.

14. The offset printing system of claim 13, wherein said vacuum device is attached to said connecting pipe.

15. The offset printing system of claim 14, wherein said vacuum device includes an upper end and a lower end.

16. The offset printing system of claim 15, wherein said connecting pipe attached to said upper end of said vacuum device that transfers a cleaning substance to said vacuum device.

17. The offset printing system of claim 1, wherein said heat exchanger includes a first heat exchanger and a second heat exchanger.

18. The offset printing system of claim 17, wherein said first heat exchanger is attached to said connecting pipe and said second heat exchanger is attached to said connecting pipe.

19. The offset printing system of claim 1, wherein said discharge pipe includes a pipe end.

20. The offset printing system of claim 19, wherein said discharge pipe includes one or more apertures.

21. The offset printing system of claim 20, wherein said apertures on said discharge pipe have varying diameters.

22. The offset printing system of claim 21, wherein said discharge pipe may be easily removable for cleaning of said offset printing system.

23. The offset printing system of claim 1, wherein a housing is insulated.

24. A process for removing excessive etch content from a polluted ink substance comprising:
a) pumping said ink substance through a suction pipe, from an ink fountain, via a first pump;
b) pumping said ink substance through a heater;
c) heating said ink substance;
d) transferring said ink substance through a first filter;
e) performing first filtration on said ink substance;
f) transferring said ink substance through a second filter;
g) performing second filtration on said ink substance;
h) transferring said ink substance through a vacuum device;
i) extracting excessive etch solution from said ink substance;
j) pumping said ink substance through a heat exchanger;
k) cooling said ink substance to appropriate printing temperature; and
l) pumping said ink substance through a discharge pipe via a second pump into said ink fountain.

25. A process for storing an ink substance comprising:
a) pumping said ink substance through a discharge pipe, from an ink fountain, via a second pump;
b) opening a second valve to allow said ink substance to transfer through a connecting pipe; and
c) storing said ink substance in a vacuum device.
